(19) United States
(12) Patent Application Publication
(10) Pub. No.: US 2026/0120031 A1
(43) Pub. Date: Apr. 30, 2026

(54) SYSTEMS AND METHODS FOR DETERMINING USER TRUST SCORES

(71) Applicant: Cisco Technology, Inc., San Jose, CA (US)

(72) Inventors: Alex Zaslavsky, Newton, MA (US); Yana Vaisman, Netanya (IL); Yulia Nevler, Raanana (IL); Nicolás Batalla Queirolo, Montevideo (UY)

(21) Appl. No.: 19/029,970

(22) Filed: Jan. 17, 2025

Related U.S. Application Data
(60) Provisional application No. 63/712,077, filed on Oct. 25, 2024.

(51) Int. Cl. G06Q 10/0635; G06F 21/57

(52) U.S. Cl. CPC G06Q 10/0635; G06F 21/577

(57) ABSTRACT

In an embodiment, a method includes detecting an event based on identity data associated with an organization, identifying within the organization a user that is associated with the event, generating a plurality of risk features including a user inherent risk feature configured to evaluate a risk of account takeover without security controls, a user behavior risk feature configured to evaluate a risk caused by behavior deviations, and a user action risk feature configured to evaluate a risk associated with actions of the first user, determining a respective weight for each risk feature, determining a user event score for the event, determining a user trust score for the user based on the plurality of risk features and their respective weights and the user event score, and generating an alert for the organization when the user trust score is below a threshold score.

### PRIORITY

This application claims the benefit, under 35 U.S.C. § 119 (e), of U.S. Provisional Patent Application No. 63/712,077, filed Oct. 25, 2024, which is incorporated herein by reference.

### TECHNICAL FIELD

This disclosure generally relates to security, and in particular relates to systems and methods for determining user trust scores.

### BACKGROUND

User often find sensitive information such as Cisco Identity Intelligence (CII) to be overwhelming. Users may struggle to understand where to start or how to prioritize the data. In certain instances, expertise with a particular platform is needed to identify particular data, such as a ‘needle in the haystack’ user that is concerning or trending towards being concerning. Due to the overwhelming amount of user context and data within CII, multiple angles and tools are often be used to identify and rate risky users.

### BRIEF DESCRIPTION OF THE DRAWINGS

FIG. 1 illustrates an example system for determining a user trust score, in accordance with certain embodiments.

FIG. 2 illustrates a graph depicting a distribution of risk, in accordance with certain embodiments.

FIGS. 3A-3B illustrate a dashboard of a model that shows a user assigned to a risk group, in accordance with certain embodiments.

FIG. 4A illustrates a dashboard of a model that shows factors that resulted in a trust level change, in accordance with certain embodiments.

FIG. 4B illustrates the dashboard of the model that shows event details associated FIG. 4A, in accordance with certain embodiments.

FIGS. 5A-5B illustrate a flow diagram of a method for determining user trust scores, in accordance with certain embodiments.

FIG. 6 illustrates a computer system, in accordance with certain embodiments.

### DESCRIPTION OF EXAMPLE EMBODIMENTS

### Overview

According to an embodiment, a system may include one or more processors and one or more computer-readable non-transitory storage media comprising instructions that, when executed by the one or more processors, cause one or more components of the system to perform operations. The operations may include detecting, based on identity data associated with a first organization, a first event of interest within a period of time. The operations may also include identifying, within the first organization, a first user that is associated with the first event. The operations may additionally include generating a plurality of risk features associated with the first user. The plurality of risk features may include at least a user inherent risk feature, a user behavior risk feature, and a user action risk feature. The user inherent risk feature may be configured to evaluate a risk of an account associated with the first user being taken over without security controls. The user behavior risk feature may be configured to evaluate a risk caused by behavior deviations of the first user. The user action risk feature may be configured to evaluate a risk associated with actions of the first user. The operations may also include determining, based on each of the plurality of risk features, a respective weight for each of the plurality of risk features. The operations may also include determining a first user event score associated with the first event of interest. The operations may additionally include determining a first user trust score for the first user within the period of time based on the plurality of risk features and their respective weights and the first user event score. The operations may further include generating an alert for the first organization when the first user trust score is below a threshold score.

In certain embodiments, the operations may include detecting a second event of interest within the period of time. The operations may also include identifying the first user that is associated with the second event. The operations may additionally include determining a second user trust score for the first user within the period of time. The operations may then include determining the first user trust score is lower than the second user trust score. The operations may further include generating the alert for the first organization when the first user trust score is below the threshold score.

In certain embodiments, the user inherent risk feature may be generated based on: a level of the first user within the first organization; a proximity of the first user to one or more second users at higher levels within the first organization; a role of the first user in the first organization; access levels of the first user to resources; or social activities associated with first user within the first organization.

In certain embodiments, the user behavior risk feature may be generated based on: account behavior associated with the first user; actions associated with the first user in a session; access data of the first user to an application; a user device associated with the first user an external risk signal associated with the first user; a password associated with the first user; a network associated with the first user; a permission associated with the first user; a multi-factor authentication (MFA) associated with the first user; or an account validity associated with the first user, the account validity indicating whether an observed account is valid or was compromised by adversary.

In certain embodiments, the user action risk feature may be generated based on: a sensitivity of resources associated with the actions; a likelihood of compromise associated with the actions; account behavior associated with the actions; a session associated with the actions; an application associated with the actions; a device associated with the actions; an external risk signal associated with the actions; a password associated with the actions; a network associated with the actions; a permission associated with the actions; a multi-factor authentication (MFA) associated with the actions; or an account validity associated with the actions, the account validity indicating whether an observed account is valid or was compromised by adversary.

In certain embodiments, the plurality of risk features may further include a user posture risk feature configured to evaluate a risk of the account associated with the first user being taken over based on an account security posture. The user posture risk feature may be generated based on: password strength; multi-factor authentication (MFA) strength; phishing susceptibility; frequent flyer; device ownership; browser irregularity; account activity; external accounts; or account configurations.

In certain embodiments, the operations may include determining one or more categories for the plurality of risk features based on correlations among the plurality of risk features. The operations may also include determining a category score of each of the categories. The operations may further include determining the first user trust score further based on the category scores of the categories.

In certain embodiments, the operations may include determining a trust level for the first user trust score corresponding to one of the following trust levels: trusted, favorable, neutral, questionable, untrusted, and unknown.

In certain embodiments, the operations may include based on the first user trust score, restricting access of the first user to sensitive applications.

In certain embodiments, the operations may include based on the first user trust score, blocking an action of the first user in a future time subsequent to the period of time.

In certain embodiments, the operations may include based on the first user trust score, re-authenticating the first user.

In certain embodiments, the operations may include based on the first user trust score, redirecting the first user to a notification page responsive to detecting an access request from the first user.

In certain embodiments, the operations may include generating an explanation for the first user trust score.

According to another embodiment, a method may include detecting, based on identity data associated with a first organization, a first event of interest within a period of time. The method may also include identifying, within the first organization, a first user that is associated with the first event. The method may additionally include generating a plurality of risk features associated with the first user. The plurality of risk features may include at least a user inherent risk feature, a user behavior risk feature, and a user action risk feature. The user inherent risk feature may be configured to evaluate a risk of an account associated with the first user being taken over without security controls. The user behavior risk feature may be configured to evaluate a risk caused by behavior deviations of the first user. The user action risk feature may be configured to evaluate a risk associated with actions of the first user. The method may also include determining, based on each of the plurality of risk features, a respective weight for each of the plurality of risk features. The method may also include determining a first user event score associated with the first event of interest. The method may additionally include determining a first user trust score for the first user within the period of time based on the plurality of risk features and their respective weights and the first user event score. The method may further include generating an alert for the first organization when the first user trust score is below a threshold score.

According to yet another embodiment, one or more computer-readable non-transitory storage media may embody instructions that, when executed by a processor, cause the performance of operations. The operations may include detecting, based on identity data associated with a first organization, a first event of interest within a period of time. The operations may also include identifying, within the first organization, a first user that is associated with the first event. The operations may additionally include generating a plurality of risk features associated with the first user. The plurality of risk features may include at least a user inherent risk feature, a user behavior risk feature, and a user action risk feature. The user inherent risk feature may be configured to evaluate a risk of an account associated with the first user being taken over without security controls. The user behavior risk feature may be configured to evaluate a risk caused by behavior deviations of the first user. The user action risk feature may be configured to evaluate a risk associated with actions of the first user. The operations may also include determining, based on each of the plurality of risk features, a respective weight for each of the plurality of risk features. The operations may also include determining a first user event score associated with the first event of interest. The operations may additionally include determining a first user trust score for the first user within the period of time based on the plurality of risk features and their respective weights and the first user event score. The operations may further include generating an alert for the first organization when the first user trust score is below a threshold score.

Technical advantages of certain embodiments of this disclosure may include one or more of the following. Certain embodiments described herein can make it simpler for CII users to focus on what is important and identify the riskiest users out of the crowd so they can remediate the situation as fast as possible, reduce the attack timeframe, and/or ultimately prevent the situation from happening at all. In some embodiments, a comprehensive user trust scoring system is provided that integrates various risk factors into a simplified, explainable model. This approach allows for dynamic risk assessment, improved access control, and enhanced threat management within a company's ecosystem. By using a combination of feature weights, categories, groups, and event scores, the disclosed system and method provides a robust and adaptive measure of user trustworthiness.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

In certain embodiments, a security system can determine user trust scores responsive to detecting events of interest, e.g., suspicious activities that occurred in identity infrastructures of an organization. Based on CII data, the security system may detect an event of interest. The security system may further identity users within the organization that are associated with the event of interest. The security system may then calculate a user trust score for each of the identified users.

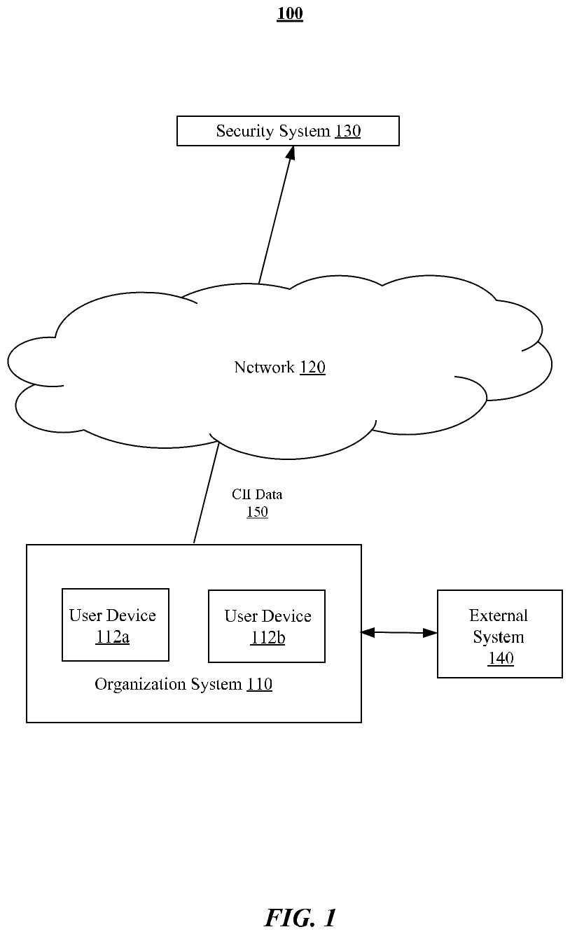

FIG. 1 illustrates an example system 100 for determining a user trust score, in accordance with certain embodiments. System 100 may include an organization system 110 associated with an organization, a network 120, a security system 130, and an external system 140.

In certain embodiments, the organization system 110 may include multiple user devices 112 that can be used to users of the organization to access resources of the organization system 110. The organization system 110 may communicate with an external system 140. For example, the external system 140 may be a cloud computing system. The organization system 100 may access computing resources provided by the external system 140.

Network 120 of system 100 is any type of network that facilitates communication between components of system 100. Network 120 may connect one or more components of system 100. One or more portions of network 120 may include an ad-hoc network, the Internet, an intranet, an extranet, a virtual private network (VPN), an Ethernet VPN (EVPN), a local area network (LAN), a wireless LAN (WLAN), a virtual LAN (VLAN), a wide area network (WAN), a wireless WAN (WWAN), a software-defined wide area network (SD-WAN), a metropolitan area network (MAN), a portion of the Public Switched Telephone Network (PSTN), a cellular telephone network, a Digital Subscriber Line (DSL), an Multiprotocol Label Switching (MPLS) network, a 3G/4G/5G network, a Long Term Evolution (LTE) network, a cloud network, a combination of two or more of these, or other suitable types of networks. Network 120 may include one or more different types of networks. Network 120 may be any communications network, such as a private network, a public network, a connection through the Internet, a mobile network, a WI-FI network, etc. Network 120 may include a core network, an access network of a service provider, an Internet service provider (ISP) network, and the like. One or more components of system 100 may communicate over network 120.

Security system 130 of system 100 may be computer hardware and/or software (e.g., a computer program) that provides security-related services to organization system 110, such as determining user trust scores and recommending actions to improve user trust scores. In certain embodiments, security system 130 accesses CII data 150 from the organization system 110 via network 120. Security system 130 may use the accessed CII data 150 to determine user trust scores for the organization.

Although FIG. 1 illustrates one organization system 110, two user devices 112, one network 120, one external system 140, and one security system 130, this disclosure contemplates any suitable number of organization system 110, user devices 112, network 120, external system 140, and security system 130. For example, there may be more than two user devices 112 in organization system 110 and there may be more than one external system 140 connected to organization system 110.

In certain embodiments, the security system 130 may determine a user trust score based on one or more of the following factors: user inherent risk, user posture risk, user behavioral risk, and user action risk.

User inherent risk may include the risk associated with a user's account being taken over assuming no security controls (e.g., easily guessable username and password). User inherent risk is a concept in risk measurement where the risk of a bad event is calculated assuming no controls are added to the system to reduce the risk. In the world of user risk, user inherent risk could be the risk of the user's account being taken over, assuming an easily guessable username and password and no other security controls (e.g., the likelihood of account takeover is 100%). In certain embodiments, user inherent risk is a function of the impact of the user's account being taken over.

User inherent risk may evaluate the risk of account takeover given a percentage (e.g., 100%) likelihood that the account will be taken over. User inherent risk may not change frequently unless a user's role is changed, or the user is provided access to new system(s).

User inherent risk may be determined based on one or more of the following: (1) organizational level and proximity to high-value targets (e.g., chief executive officer (CEO)); (2) role in the organization, with specific roles like information technology (IT) administrators carrying more weight; (3) access to resources, including sensitivity and privilege levels; and (4) enhancement, considering social dynamics such as frequent communication with high-value targets, to extend the blast radius beyond direct IT resource access.

User posture risk may include the risk of account takeover based on account security posture. For example, by examining the password strength, multi-factor authentication (MFA) strength, the age of the account, and/or other signals, a posture can be determined based on configuration and other information.

User posture risk may evaluate the risk of account takeover given how easy it would be to take over this account. User posture risk may fluctuate infrequently (e.g., on the order of days), as variables like password strength and MFA device registration do not change that often.

In certain embodiments, user posture risk may be determined based on one or more of the following: (1) password strength (e.g., length, complexity, breach appearance, age, etc.); (2) MFA strength (e.g., phishing resistance, recent registration, shared factors, etc.); (3) phishing susceptibility (e.g., click rates on phishing links and visiting questionable domains); (4) frequent flyer (e.g., travel patterns affecting baseline establishment); (5) device ownership (e.g., personal vs. corporate-managed devices); (6) browser irregularity (e.g., use of non-standard or outdated browsers); (7) account activity (e.g., recent creation, administrative role assignment, dormancy, and/or attack frequency); (8) external accounts (e.g., guest accounts, contractors vs. regular employees, etc.); and (9) account configurations (e.g., long session token timeouts).

User behavioral risk may include the risk influenced by deviations from the user's normal behavior and patterns. In certain embodiments, user behavioral risk may influence the likelihood of a bad action, based on a deviation of the user's normal behavior. By baselining a user's normal access and authentication patterns, deviations can be recognized and compared to their past behavior and the behavior of other users in the same team or organization.

User behavioral risk may evaluate the risk of account takeover given the recent actions or activities of the user. User behavior risk may change over the span of hours. No individual action is typically the trigger for heighten behavioral risk, but a series of actions might lead to an elevated behavior risk.

In certain embodiments, user behavioral risk may be determined based on one or more of the following: (1) account behavior (e.g., age and history of internet protocol (IP) addresses, devices, Internet Service Providers (ISPs)/Autonomous System Numbers (ASNs), impossible travel events, Single Sign On (SSO) bypass, and/or multiple failed PowerShell events); (2) actions in the session (e.g., unusual administrative actions); (3) application (e.g., administrative logins, first-time access to sensitive applications); and (4) device/user agent (e.g., use of unmanaged devices or rare browsers).

User action risk may include the risk associated with specific user actions. In certain embodiments, user action risk may be determined based on the sensitivity of the resource and the likelihood of compromise based on current signals. User action risk may evaluate a specific action, such as whether the chief financial officer (CFO) should be able to access the corporate enterprise resource planning (ERP) system as an administrator while signing in from a new laptop, located in Amsterdam, with a second factor authentication that was registered in the past seven days and has a medium assurance level. The level of specificity for an action can be important for allowing, denying, or challenging individual actions taken by individual users. In certain embodiments, determining user action risk may depend on the sensitivity of the resource being accessed and the combined likelihood of these signals at the time of access.

User action risk may evaluate the risk of account takeover given the action the user is trying to take at this point in time. User action risk may vary on an instantaneous basis for each action a user takes. For example, user action risk may vary instantaneously with each action a user takes, considering factors such as location, device type, and/or recent authentication history.

Additional factors for determining user behavioral risk and user action risk may include one or more of the following: (1) account behavior (e.g., age of IP, device, internet service provider (ISP)/autonomous system number (ASN), impossible travel, single sign-on (SSO) bypass, multiple failed events associated with a cross-platform task automation and configuration management framework); (2) actions in the session (e.g., unusual administrative actions); (3) application (e.g., administrative logins, first-time access to sensitive applications); (4) device/user agent (e.g., use of unmanaged or rare devices/browsers, shared devices); (5) external threat signals (e.g., risk signals from a cloud computing platform); (6) password (e.g., recent changes); (7) network (e.g., flagged IP addresses by threat intelligence, untrustworthy ISPs, blocked countries, new IPs for tenants, etc.); (8) permissions (e.g., administrative impersonation, recently assigned administrative roles, cloud-only accounts, etc.); (9) MFA (e.g., use of weak factors, MFA flooding detection, shared authenticators, recent MFA registration or reset, bypass tokens, multiple failed MFA modification attempts, etc.); (10) session (e.g., parallel sessions, session hijacking, long-running session tokens, etc.); and (11) valid accounts (e.g., invalid employees, new identity providers, account age, shared mailboxes, service account sign-ins, accounts under attack, external email forwarding, users without strong MFA, special accounts (administrative or executive), inactive accounts, etc.).

In certain embodiments, the security system 130 may generate features for user inherent risk, user posture risk, user behavioral risk, and user action risk associated with a user. The security system 130 may further determine a user trust score based on the features.

In certain embodiments, the security system 130 may use a model to calculate a user trust score. The model may include determining single feature weight assignment. The single feature weight assignment may be assigned from one or more (e.g., seven) possible weights (e.g., 0; ±1; ±3; ±5) to represent feature risk. In certain embodiments, each feature may have values that trigger specific weights (e.g., a new IP).

In certain embodiments, the model may include determining one or more categories and category scoring. A category may be used to manage correlated features. A category score may represent the maximum score among all features in the category.

In some embodiments, the model may include determining one or more groups and a group score. A group may be used to simplify explain-ability. The preliminary score of a group may represent the sum of all features and category weights. The final group score may be bucketized into two or more (e.g., four) weights (e.g., 0 (no risk), 1 (low risk), 3 (medium risk), 5 (high risk)).

In certain embodiments, the group can be determined based on account login behavior, actions in session, an application, a device, an external threat, one or more factors (e.g., a first factor and a second factor), a network, permissions, a session, and/or valid accounts.

For the group associated with account login behavior, the base pattern may include a new IP, a new device, an observed device, a known device, a new ISP, a known ISP, a new country, an impossible travel, a new country for a tenant, an account logged in directly to resource instead of an identity provider (IdP), a successful access from a previously failing IP, multiple power shell commands failed, etc. The security system 130 may perform checks for these based patterns, e.g., high-frequency failed sign-ins for successful access from previously failing IP. For each base pattern, the security system 130 may generate the feature and determine the associated weight.

For the group associated with actions in a session, the base pattern may include unusual operations in an identity provider (IdP), lateral movement, and exfiltration. The security system 130 may perform checks for these based patterns, e.g., code exfiltration by guest account for exfiltration. For each base pattern, the security system 130 may generate the feature and determine the associated weight.

For the group associated with application, the base pattern may include login to an admin portal, a sensitive action, an account accessing a sensitive app for the first time, a login to a sensitive app, etc. The security system 130 may perform checks for these based patterns and generate features and determine their associated weights.

For the group associated with a device, the base pattern may include unmanaged devices, rare device, and a same machine on multiple accounts. The security system 130 may perform checks for these based patterns, e.g., unmanaged devices access for unmanaged devices. For each base pattern, the security system 130 may generate the feature and determine the associated weight.

For the group associated with an external threat, the base pattern may include a risk from a cloud platform. The security system 130 may perform a check for the based pattern, e.g., risky user sign-in events. For the base pattern, the security system 130 may generate the feature and determine the associated weight.

For the group associated with a factor (e.g., a first factor), the base pattern may include password recently changed and account failed to change password. The security system 130 may perform checks for these based patterns and generate features and determine their associated weights.

For the group associated with a network, the base pattern may include bad IP, bad ISP, probing intrusion prevention system (Ips), denied country, trusted network for organization, new IP for tenant, and num account that IP is new for them (not prevalent). The security system 130 may perform check for the based pattern, e.g., activity from untrustworthy ISP for bad ISP. For the base patterns, the security system 130 may generate the features and determine their associated weights.

For the group associated with permissions, the base pattern may include admin impersonation, recently becoming admin, role assigned to cloud account. The security system 130 may perform check for the based pattern and generate the features and determine their associated weights.

For the group associated with a factor (e.g., a second factor), the base pattern may include weak MFA used in first time, MFA flood, shared authenticator, same MFA registered, all MFA recently disabled, weak MFA added by admin, bypass token used, multiple failed attempts to modify MFA, weak MFA used, and shared authenticator in use. The security system 130 may perform check for the based pattern, e.g., telecom MFA limit reached for MFA flood. For the base patterns, the security system 130 may generate the features and determine their associated weights.

For the group associated with a session, the base pattern may include parallel sessions, session hijack, and long session with cloud-based identity management platform. The security system 130 may perform check for the based pattern and generate the features and determine their associated weights.

For the group associated with valid accounts, the base pattern may include not valid employee, login from newly created IdP, new account, equipment can logging in, system admin login, equipment logging in, probed account, recently probed account, account added external forwarding email, user with no strong MFA, special account (e.g., admin/executive), inactive account, resurrected account, and hybrid identity in use. The security system 130 may perform check for the based pattern, e.g., shared mailbox enabled for equipment can logging in and active account under heavy attacks for probed account. For the base patterns, the security system 130 may generate the features and determine their associated weights.

In certain embodiments, the model used to calculate a user trust score may include determining a user event score. The user event score may be used to measure how “far” the event score is from significantly risky behavior. Based on the highest risk scores from all groups (e.g., the eleven groups described above), the user event score may be significant when three or more groups are high-risk.

The model may further include determining a user trust score. In certain embodiments, a user trust score can be determined by the maximum final score for all events within a given period of time (e.g., past day, past week).

The model may additionally include a self-control mechanism. The self-control mechanism may be used to control false positives. For example, if daily risky accounts exceed one percent of the total workforce, a user trust score may be reassessed.

In an example embodiment, a user trust score may be based on the following model calculation:

$$S = 100 \times ( 1 - \frac{max PossibleGroupScore \times min RiskyGroups - {\sum }_{i = 1}^{n} {GW}_{i}}{max PossibleGroupScore \times min RiskyGroups} )$$

where n indicates the number of groups, GWᵢ indicates a specific group weight, maxPossibleGroupScore may be 5 as an example, and minRiskyGroups may be 3 as an example.

In certain embodiments, the security system 130 may further determine trust levels based on user trust scores. The trust levels may be used in lieu of or in combination with numerical user trust scores. Trust levels may include one or more of the following: trusted, favorable, neutral, questionable, untrusted, and unknown. In certain embodiments, “trusted” may represent exceptional safety (e.g., trust level 0-5 out of 100); “favorable” may represent safe (e.g., a trust level of 6-30 out of 100); “neutral” may represent neither positive nor negative (e.g., a trust level of 31-60 out of 100); “questionable” may represent a potential risk (e.g., a trust level of 61-80 out of 100); “untrusted” may represent high risk or malicious behavior (e.g., a trust level of 81-100 out of 100); and “unknown” may represent not evaluated or lacking data.

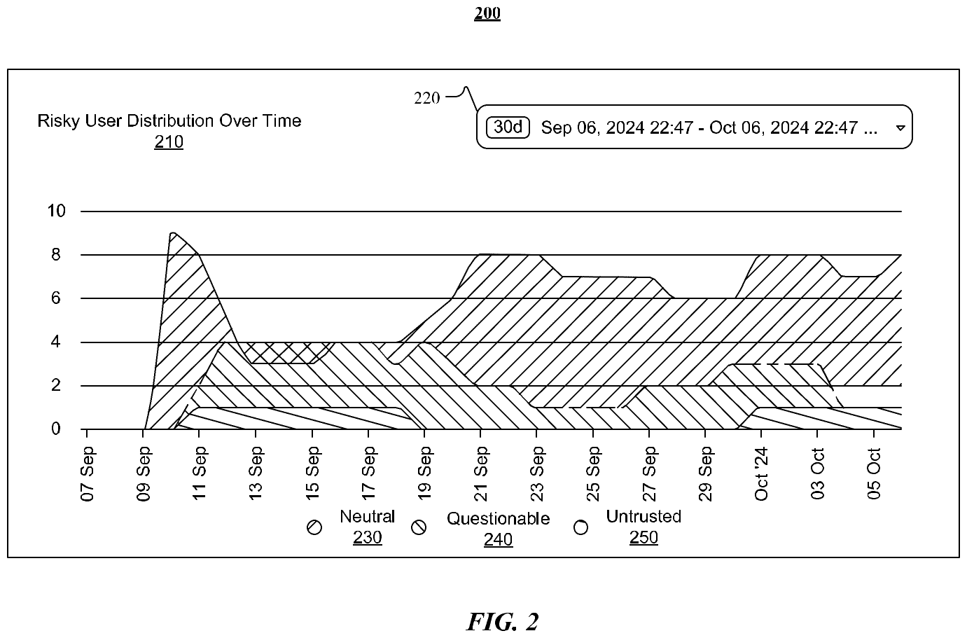

FIG. 2 illustrates a graph 200 depicting a distribution of risk, in accordance with certain embodiments. The graph 200 of FIG. 2 shows risky user distribution 210 over time. The distribution 210 is based on a certain period of time 220. For example, the period of time 220 may be 30 days from Sep. 6, 2024, 22:47 pm to Oct. 6, 2024, 22:47 pm. In the illustrated embodiment of FIG. 2, the trust levels include a neutral trust level 230, a questionable trust level 240, and an untrusted trust level 250 at a scale of 0-10. The distribution of risk may allow a support team to define the amount of acceptable risk to access a resource without overwhelming the support team.

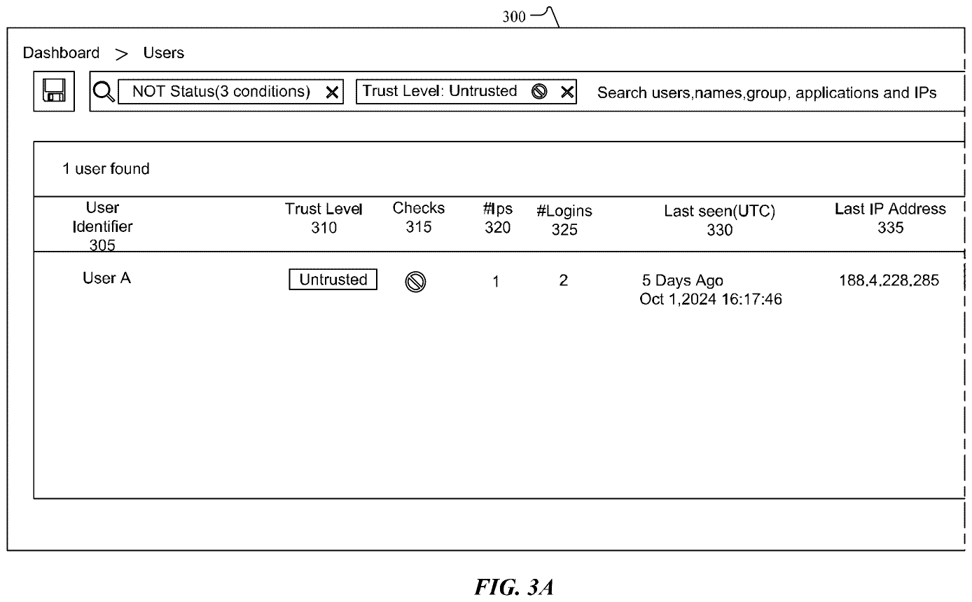

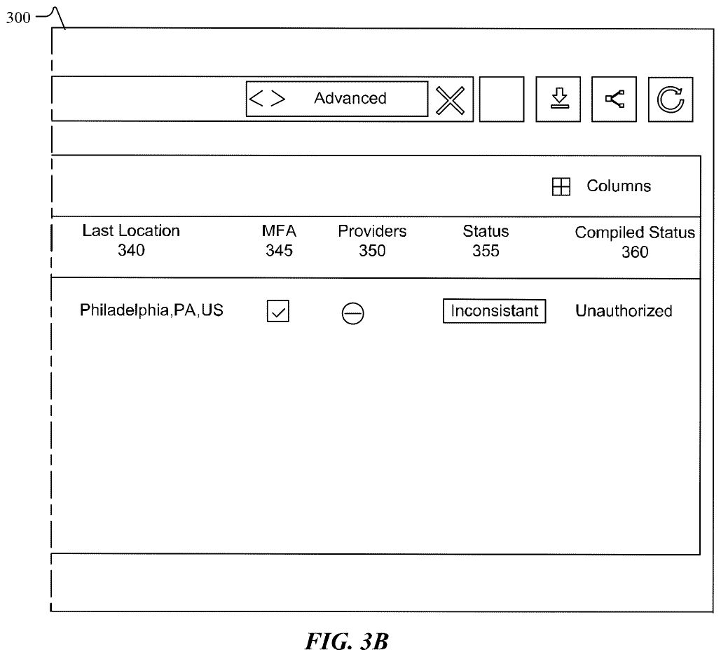

FIGS. 3A-3B illustrate a dashboard 300 of a model that shows a user assigned to a risk group, in accordance with certain embodiments. In the illustrated embodiment of FIG. 3A, the model identified one user in the untrusted trust level category. The dashboard 300 illustrates the following information associated with the identified user: user identifier 305 (e.g., name, email, etc.), trust level 310, checks 315, number of Ips 320, number of logins 325, last time user was seen 330, last IP address 335, last location of user 340, whether user is associated with an MFA 345, providers 350, provider status 355, and complied status 360. Specifically for user A, the trust level 310 is untrusted, the number of Ips 320 is 1, the number of logins 325 is 2, last time user was seen 330 was 5 days ago, Oct. 1, 2024, UTC at 16:17:46, last IP address 335 is 188.4.228.285, last location of user 340 was Philadelphia, PA, US, user A is associated with an MFA 345, provider status 355 is inconsistent, and complied status 360 is unauthorized.

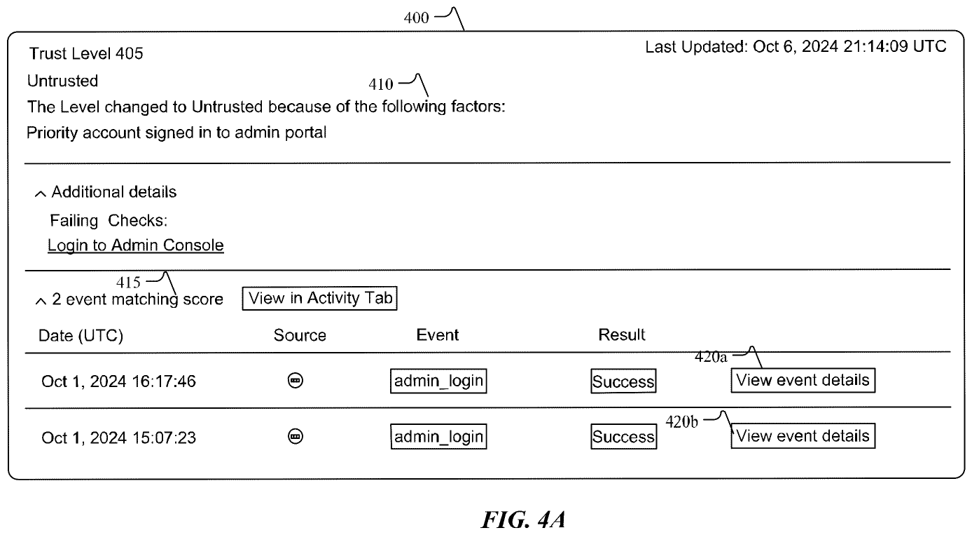

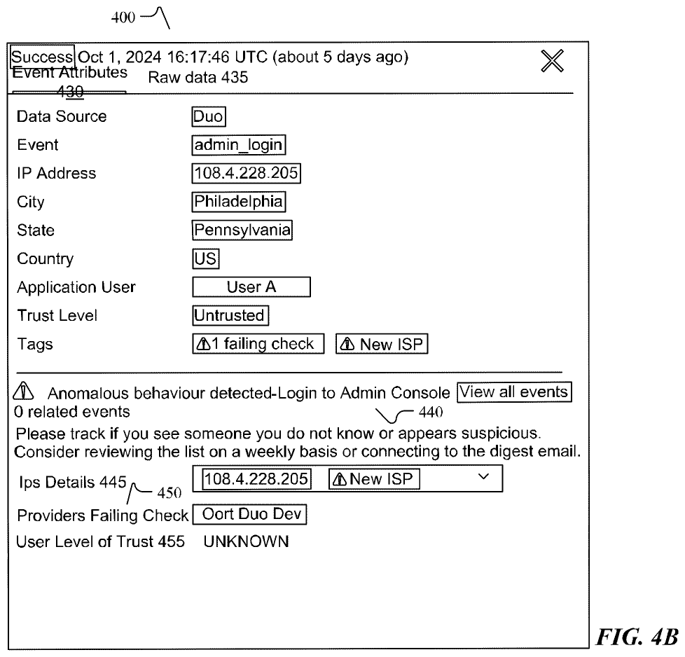

FIG. 4A illustrates a dashboard 400 of a model that shows factors that resulted in a trust level change, in accordance with certain embodiments. In the illustrated embodiment of FIG. 4A, the model notes that the trust level 405 changed to ‘untrusted’. The model also determined the factor 410 caused the level change, e.g., a priority account signed into an administrative portal. The dashboard 400 also shows two events matching scores 415 includes two administrative login events on the same day.

FIG. 4B illustrates the dashboard 400 of the model that shows event details associated FIG. 4A, in accordance with certain embodiments. Referring to FIG. 4A, a user can click on “view event details 420” associated with each of the events under event matching scores 415. In the illustrated embodiment of FIG. 4B, the event details include event attributes 430 and raw data 435. The event attributes 430 include the following attributes: a data source (Duo), an event (admin_login), an IP address, a city (Philadelphia), a state (Pennsylvania), a country (US), an application user (User A), a trust level (untrusted), and tags (1 failing check and a new ISP). The dashboard 400 of FIG. 4B also includes the following alert 440: “Anomalous behavior detected-Login to Admin Console; Please track if you see anyone you do not know or appears suspicious. Consider reviewing the list on a weekly basis or connecting to the digest email.” The dashboard 400 further indicates the intrusion prevention system (Ips) details 445, the provider's failing check 450 (Oort Duo Dev), and a user level of trust 455 (unknown).

In certain embodiments, based on user trust scores, the security system 130 may restrict access for risky users. For example, the security system 130 may restrict a user's access to sensitive applications if the user is determined to be ‘untrusted’ or ‘questionable’.

In some embodiments, the security system 130 blocks or challenges suspicious actions. For real-time assessments, the security system 130 may use a combination of user trust score, device posture, device risk score, and local values to determine whether to block or challenge suspicious actions. For example, the security system 130 may re-authenticate the user, block actions by the user, or redirect the user to a notification page.

The security system 130 may prioritize high-risk users for investigation. For example, the security system 130 may inform analysts about high-risk users who need immediate attention, which may be useful for incident prioritization and to highlight top risky users.

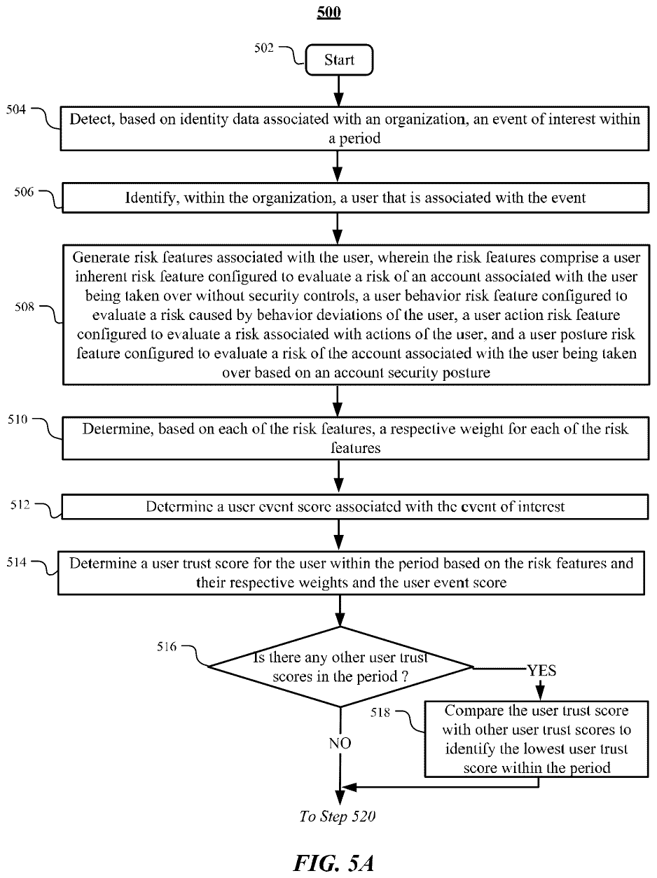

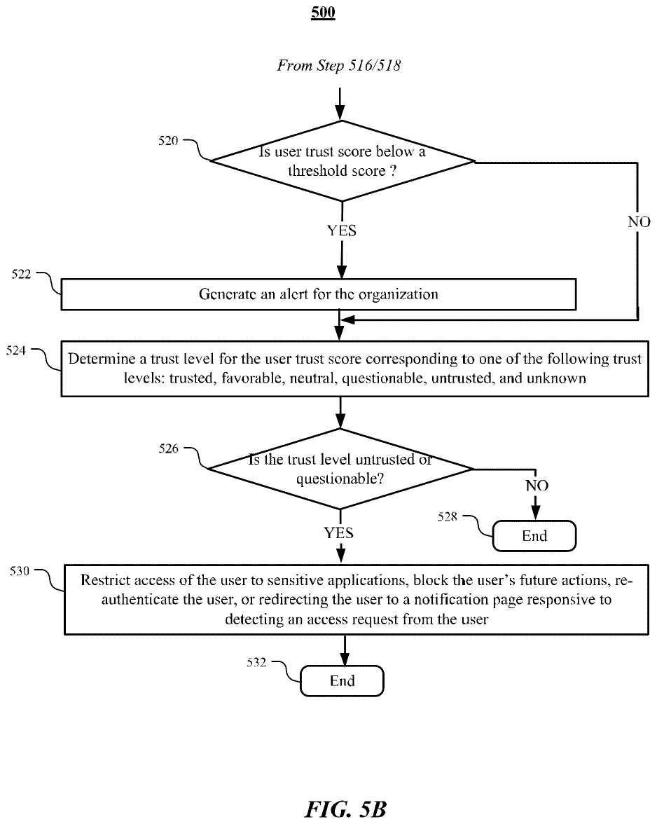

FIGS. 5A-5B illustrate a flow diagram of a method 500 for determining user trust scores, in accordance with certain embodiments. In an embodiment, the steps of method 500 may be performed by a security system 130. The method may start at step 502.

At step 504, the security system 130 may detect, based on identity data associated with an organization, an event of interest within a period of time.

At step 506, the security system 130 may identify, within the organization, a user that is associated with the event.

At step 508, the security system 130 may generate risk features associated with the user. The risk features may include a user inherent risk feature configured to evaluate a risk of an account associated with the user being taken over without security controls, a user behavior risk feature configured to evaluate a risk caused by behavior deviations of the user, a user action risk feature configured to evaluate a risk associated with actions of the user, and a user posture risk feature configured to evaluate a risk of the account associated with the user being taken over based on an account security posture.

At step 510, the security system 130 may determine, based on each of the risk features, a respective weight for each of the risk features.

At step 512, the security system 130 may determine a user event score associated with the event of interest.

At step 514, the security system 130 may determine a user trust score for the user within the period of time based on the risk features and their respective weights and the user event score.

At step 516, the security system 130 may determine whether there are any other user trust scores calculated for this user within this period of time. If there are no other user trust scores, method 500 may proceed to step 520.

If, at step 516, there are other user trust scores, the security system 130 may compare the user trust score with other user trust scores to identify the lowest user trust for this user within this period of time at step 518. Method 500 may then proceed to step 520.

At step 520, the security system 130 may determine whether the user trust score is below a threshold score. If the user trust score is below a threshold score, method 500 may proceed to step 522. If the user trust score is not below a threshold score, method 500 may proceed to step 524.

At step 522, the security system 130 may generate an alert about the user for the organization. For example, the alert may be transmitted to security operating team of the organization or any other user that is responsible for monitoring the security alerts associated with the organization.

At step 524, the security system 130 may determine a trust level for the user trust score corresponding to one of the following trust levels: trusted, favorable, neutral, questionable, untrusted, and unknown.

At step 526, the security system 130 may determine whether the trust level is untrusted or questionable. If the trust level is not untrusted or questionable, method 500 may end at step 528. If the trust level is untrusted or questionable, method 500 may proceed to step 530.

At step 530, the security system 130 may restrict access of the user to sensitive applications, block the user's future actions, re-authenticate the user, or redirecting the user to a notification page responsive to detecting an access request from the user.

At step 532, the method may end.

Although this disclosure describes and illustrates particular steps of method 500 of FIGS. 5A-5B as occurring in a particular order, this disclosure contemplates any suitable steps of method 500 of FIGS. 5A-5B occurring in any suitable order. Although this disclosure describes and illustrates an example method for determining user trust scores including the particular steps of method 500 of FIGS. 5A-5B, this disclosure contemplates any suitable method for determining user trust scores including any suitable steps, which may include all, some, or none of the steps of method 500 of FIGS. 5A-5B, where appropriate. Furthermore, although FIGS. 5A-5B describe and illustrate particular components, devices, or systems carrying out particular actions, this disclosure contemplates any suitable combination of any suitable components, devices, or systems carrying out any suitable actions.

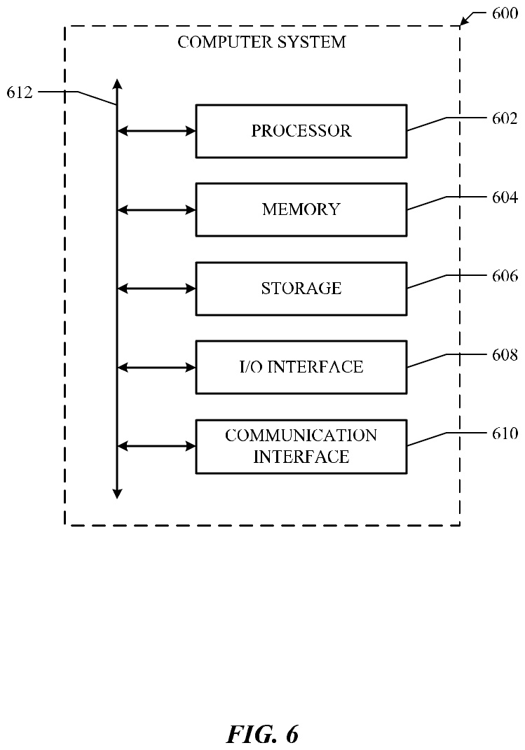

FIG. 6 illustrates an example computer system 600. In particular embodiments, one or more computer system 600 perform one or more steps of one or more methods described or illustrated herein. In particular embodiments, one or more computer system 600 provide functionality described or illustrated herein. In particular embodiments, software running on one or more computer system 600 performs one or more steps of one or more methods described or illustrated herein or provides functionality described or illustrated herein. Particular embodiments include one or more portions of one or more computer system 600. Herein, reference to a computer system may encompass a computing device, and vice versa, where appropriate. Moreover, reference to a computer system may encompass one or more computer systems, where appropriate.

This disclosure contemplates any suitable number of computer system 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 600 may include one or more computer system 600; be unitary or distributed; span multiple locations; span multiple machines; span multiple data centers; or reside in a cloud, which may include one or more cloud components in one or more networks. Where appropriate, one or more computer system 600 may perform without substantial spatial or temporal limitation one or more steps of one or more methods described or illustrated herein. As an example, and not by way of limitation, one or more computer system 600 may perform in real time or in batch mode one or more steps of one or more methods described or illustrated herein. One or more computer system 600 may perform at different times or at different locations one or more steps of one or more methods described or illustrated herein, where appropriate.

In particular embodiments, computer system 600 includes a processor 602, a memory 604, a storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer system 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Additionally, although this disclosure describes or illustrates particular embodiments as providing particular advantages, particular embodiments may provide none, some, or all of these advantages.

The embodiments disclosed herein are only examples, and the scope of this disclosure is not limited to them. Particular embodiments may include all, some, or none of the components, elements, features, functions, operations, or steps of the embodiments disclosed herein. Embodiments disclosed herein include a method, an apparatus, a storage medium, a system and a computer program product, wherein any feature mentioned in one category, e.g., a method, can be applied in another category, e.g., a system, as well.

What is claimed is:

1. A system, comprising:
one or more processors; and
one or more computer-readable non-transitory storage media comprising instructions that, when executed by the one or more processors, cause one or more components of system to perform operations comprising:
detecting, based on identity data associated with a first organization, a first event of interest within a period of time;
identifying, within the first organization, a first user that is associated with the first event;
generating a plurality of risk features associated with the first user, wherein the plurality of risk features comprises at least a user inherent risk feature, a user behavior risk feature, and a user action risk feature, wherein the user inherent risk feature is configured to evaluate a risk of an account associated with the first user being taken over without security controls, wherein the user behavior risk feature is configured to evaluate a risk caused by behavior deviations of the first user, and wherein the user action risk feature is configured to evaluate a risk associated with actions of the first user;
determining, based on each of the risk features, a respective weight for each of the plurality of risk features;
determining a first user event score associated with the first event of interest;
determining a first user trust score for the first user within the period of time based on the plurality of risk features and their respective weights and the first user event score; and
generating an alert for the first organization when the first user trust score is below a threshold score.

2. The system of claim 1, the operations further comprising:
detecting a second event of interest within the period of time;
identifying the first user that is associated with the second event;
determining a second user trust score for the first user within the period of time;
determining the first user trust score is lower than the second user trust score; and
generating the alert for the first organization when the first user trust score is below the threshold score.

3. The system of claim 1, wherein the user inherent risk feature is generated based on one or more of:
a level of the first user within the first organization;
a proximity of the first user to one or more second users at higher levels within the first organization;
a role of the first user in the first organization;
access levels of the first user to resources; or
social activities associated with first user within the first organization.

4. The system of claim 1, wherein the user behavior risk feature is generated based on one or more of:
account behavior associated with the first user;
actions associated with the first user in a session;
access data of the first user to an application;
a user device associated with the first user;
an external risk signal associated with the first user;
a password associated with the first user;
a network associated with the first user;
a permission associated with the first user;
a multi-factor authentication (MFA) associated with the first user; or
an account validity associated with the first user, the account validity indicating whether an observed account is valid or was compromised by adversary.

5. The system of claim 1, wherein the user action risk feature is generated based on:
a sensitivity of resources associated with the actions;
a likelihood of compromise associated with the actions;
account behavior associated with the actions;
a session associated with the actions;
an application associated with the actions;
a device associated with the actions;
an external risk signal associated with the actions;
a password associated with the actions;
a network associated with the actions;
a permission associated with the actions;
a multi-factor authentication (MFA) associated with the actions; or
an account validity associated with the actions, the account validity indicating whether an observed account is valid or was compromised by adversary.

6. The system of claim 1, wherein the plurality of risk features further comprise a user posture risk feature configured to evaluate a risk of the account associated with the first user being taken over based on an account security posture, and wherein the user posture risk feature is generated based on:
password strength;
multi-factor authentication (MFA) strength;
phishing susceptibility;
frequent flyer;
device ownership;
browser irregularity;
account activity;
external accounts; or
account configurations.

7. The system of claim 1, the operations further comprising:
determining one or more categories for the plurality of risk features based on correlations among the plurality of risk features;
determining a category score of each of the categories; and
determining the first user trust score further based on the category scores of the categories.

8. The system of claim 1, the operations further comprising:
determining a trust level for the first user trust score corresponding to one of: trusted, favorable, neutral, questionable, untrusted, and unknown.

9. The system of claim 1, the operations further comprising:
based on the first user trust score, restricting access of the first user to sensitive applications.

10. The system of claim 1, the operations further comprising:
based on the first user trust score, blocking an action of the first user in a future time subsequent to the period of time.

11. The system of claim 1, the operations further comprising:
based on the first user trust score, re-authenticating the first user.

12. The system of claim 1, the operations further comprising:
based on the first user trust score, redirecting the first user to a notification page responsive to detecting an access request from the first user.

13. The system of claim 1, the operations further comprising:
generating an explanation for the first user trust score.

14. A method, comprising:
detecting, based on identity data associated with a first organization, a first event of interest within a first period of time;
identifying, within the first organization, a first user that is associated with the first event;
generating a plurality of risk features associated with the first user, wherein the plurality of risk features comprise at least a user inherent risk feature, a user behavior risk feature, and a user action risk feature, wherein the user inherent risk feature is configured to evaluate a risk of an account associated with the first user being taken over without security controls, wherein the user behavior risk feature is configured to evaluate a risk caused by behavior deviations of the first user, and wherein the user action risk feature is configured to evaluate a risk associated with actions of the first user;
determining, based on each of the plurality of risk features, a respective weight for each of the plurality of risk features;
determining a first user event score associated with the first event of interest;
determining a first user trust score for the first user within the first period of time based on the plurality of risk features and their respective weights and the first user event score; and
generating an alert for the first organization when the first user trust score is below a threshold score.

15. The method of claim 14, further comprising:
detecting a second event of interest within the first period of time;
identifying the first user that is associated with the second event;
determining a second user trust score for the first user within the first period of time;
determining the first user trust score is lower than the second user trust score; and
generating the alert for the first organization when the first user trust score is below the threshold score.

16. The method of claim 14, further comprising:
based on the first user trust score, restricting access of the first user to sensitive applications.

17. The method of claim 14, further comprising:
based on the first user trust score, blocking an action of the first user in a future time subsequent to the first period of time.

18. A non-transitory computer-readable medium comprising instructions that are configured, when executed by a processor, to:
detect, based on identity data associated with a first organization, a first event of interest within a first period of time;
identify, within the first organization, a first user that is associated with the first event;
generate a plurality of risk features associated with the first user, wherein the plurality of risk features comprise at least a user inherent risk feature, a user behavior risk feature, and a user action risk feature, wherein the user inherent risk feature is configured to evaluate a risk of an account associated with the first user being taken over without security controls, wherein the user behavior risk feature is configured to evaluate a risk caused by behavior deviations of the first user, and wherein the user action risk feature is configured to evaluate a risk associated with actions of the first user;
determine, based on each of the plurality of risk features, a respective weight for each of the plurality of risk features;
determine a first user event score associated with the first event of interest;
determine a first user trust score for the first user within the first period of time based on the plurality of risk features and their respective weights and the first user event score; and
generate an alert for the first organization when the first user trust score is below a threshold score.

19. The non-transitory computer-readable medium of claim 18, further comprising instructions that are configured, when executed by a processor, to:
detect a second event of interest within the first period of time;
identify the first user that is associated with the second event;
determine a second user trust score for the first user within the first period of time;
determine the first user trust score is lower than the second user trust score; and
generate the alert for the first organization when the first user trust score is below the threshold score.

20. The non-transitory computer-readable medium of claim 18, further comprising instructions that are configured, when executed by a processor, to:
based on the first user trust score, restricting access of the first user to sensitive applications.
